(19) United States
(12) Patent Application Publication
(10) Pub. No.: US 2014/0040830 A1
(43) Pub. Date: Feb. 6, 2014

(54) USER INTERFACE - STATUS BAR

(71) Applicant: BSH HOME APPLIANCES CORPORATION, Irvine, CA (US)

(72) Inventors: Phillip Montanye, New Bern, NC (US); Graham Sadtler, Huntington Beach, CA (US); Elysa Soffer, San Francisco, CA (US); Robert Tannen, Philadelphia, PA (US)

(73) Assignee: BSH HOME APPLIANCES CORPORATION, Irvine, CA (US)

(21) Appl. No.: 13/735,255

(22) Filed: Jan. 7, 2013

Related U.S. Application Data
(63) Continuation-in-part of application No. 29/428,663, filed on Aug. 2, 2012.

(51) Int. Cl. G06F 3/0482

(52) U.S. Cl. CPC G06F 3/0482
USPC 715/841

(57) ABSTRACT

A method for controlling a domestic appliance, said domestic appliance having a display with a first portion and a second portion, a controller, and at least one user input component, the method comprising: displaying a menu in the first portion, detecting user input associated with a first parameter of said menu with the at least one user input component, displaying a first submenu in the second portion, detecting user input associated with a first parameter value of said first submenu with the at least one user input component, displaying the first parameter value in the menu in the first portion, and displaying a second submenu associated with a second parameter in the second portion.

### CROSS-REFERENCE TO APPLICATION

This application claims the benefit of and is a continuation-in-part of U.S. Design application No. 29/428,663, filed Aug. 2, 2012, which is incorporated herein by reference in its entirety.

### FIELD OF THE INVENTION

The present technology relates to user interfaces for household appliances to treat items, e.g., ovens. More particularly to a status bar for the interface that displays and facilitates the editing of operational parameters, e.g., treatment mode, treatment temperature and/or treatment duration, and thereof.

### BACKGROUND OF THE INVENTION

Household appliances today commonly incorporate a complex user interface to provide for the display of information. These user interfaces incorporate a display screen to display complex information or images and controllers with CPUs to drive the more complex content to the display. These common household appliances can display a variety of information and receive a number of inputs from the user.

These appliance user interfaces, however, may display only one parameter at a time, as it is being inputted or edited. For example, the user would choose to input the treatment mode from a variety of operational parameters and the user interface would then exclusively show the treatment mode options. The user would then choose the desired treatment mode, which would set that treatment mode as an operational parameter in the controller and then the user interface would return to the screen which displays a variety of operational parameters.

Alternatively, the user interface may persistently display a variety of parameter options for inputting or editing, but only the parameter actually being edited is displayed. For example, there may be a number of buttons that represent treatment mode, treatment temperature, and treatment duration. Universal buttons to adjust parameter values would also be provided. The user would choose a parameter to input or edit, then input or edit the desired value, but only information pertaining to that particular parameter would be displayed. To view the values of other parameters the user would then have to choose another of the parameter options.

Ultimately, in either of these options the user is limited as to the amount of information available during programming the operation of the appliance. The user is further required to perform an additional and affirmative step of changing parameter options to view, input, or edit the subsequent parameter.

### SUMMARY OF THE INVENTION

One aspect of the present technology is to provide a method for controlling a domestic appliance that overcomes one or more shortcomings of the prior art.

Another aspect of the present technology is directed to a method for controlling a domestic appliance. The domestic appliance includes a display with a first portion and a second portion, a controller, and at least one user input component. The method includes displaying a menu in the first portion, detecting user input associated with a first parameter of said menu, displaying a first submenu in the second portion, detecting user input associated with a first parameter value from said first submenu, displaying the first parameter value in the menu in the first portion, and displaying a second submenu associated with a second parameter in the second portion.

In examples, (a) the first parameter and the second parameter each may comprise a different one of a treatment mode, a treatment temperature, and a treatment time, (b) the first parameter value may comprise one of a plurality of treatment modes, one of a plurality of treatment temperatures, or one of a plurality of treatment times, (c) the first menu may be persistently displayed in said first portion independent of the submenus displayed in said second portion, (d) the domestic appliance may comprise at least one treatment element; and the method may comprise treating contents within a treatment chamber enclosed by a door with the at least one treatment element according to at least the first parameter value, (e) the method may comprise displaying a plurality of parameter values in the menu in the first portion, and/or (f) each said submenu may comprise a plurality of parameter values associated with each respective submenu parameter.

Another aspect of the present technology is directed to a domestic appliance to treat contents. The domestic appliance includes a display with a first portion and a second portion, at least one user input component configured to detect user input, and a controller programmed to: instruct the display to display a menu in the first portion, receive user input associated with a first parameter of said menu from the at least one user input component, instruct the display to display a first submenu in the second portion, receive user input associated with a first parameter value of said first submenu from the at least one user input component, instruct the display to display the first parameter value in the menu in the first portion, and instruct the display to display a second submenu associated with a second parameter in the second portion.

In examples, (a) the first parameter and the second parameter each may comprise a different one of a treatment mode, a treatment temperature, and a treatment time, (b) the first parameter value may comprise one of a plurality of treatment modes, one of a plurality of treatment temperatures, or one of a plurality of treatment times, (c) the controller may be programmed to instruct the display to persistently display the menu in said first portion independent of the submenus displayed in said second portion, and (d) the domestic appliance may further comprise at least one treatment element, a treatment chamber, and a door to enclose the treatment chamber, wherein the controller is programmed to instruct the at least one treatment element to treat the contents within the treatment chamber enclosed by the door with the at least one treatment element according to at least the first parameter value.

Another aspect of the present technology is directed to a method for displaying at least one operational parameter associated with a user interface of a domestic appliance, said user interface having a display with a first portion and a second portion adjacent to the first portion and having at least one user input component. The method includes displaying a first screen associated with a first operational parameter in the first portion; detecting user input to the first portion with the at least one user input component; displaying the first operational parameter in the second portion based on the user input to the first portion; displaying a second screen associated with a second operational parameter in the first portion; detecting user input to the first portion with the at least one user input component; displaying the second operational parameter in the second portion based on the user input to the first portion; detecting user input associated with the first operational parameter to the second portion with the at least one user input component; and displaying the first screen in the first portion.

In examples, (a) the parameter may comprise a treatment mode, a treatment time, or a treatment temperature, (b) the method may comprise displaying a treatment mode screen; receiving a treatment mode input corresponding to a treatment mode from the at least one user input component; displaying a treatment temperature screen; receiving a treatment temperature input corresponding to a treatment temperature from the at least one user input component; displaying a set timer screen; receiving a set timer input from the at least one user input component; displaying a treatment time screen; and receiving a treatment time input corresponding to a treatment time from the at least one user input component, (c) the method may comprise programming the timer to track treatment time, (d) the method may comprise tracking a treatment time with the timer, and/or (e) the method may comprise treating contents of the domestic appliance with at least one treatment element for the duration of the treatment time.

Another aspect of the present technology is directed to a domestic appliance to treat contents. The domestic appliance includes a display with a first portion and a second portion, at least one user input component configured to detect user input, and a controller programmed to: instruct the display to display a first screen associated with a first operational parameter in the first portion, receive user input to the first portion detected by the at least one user input component, instruct the display to display the first operational parameter in the second portion based on the user input to the first portion, instruct the display to display a second screen associated with a second operational parameter in the first portion, receive user input to the first portion detected by the at least one user input component, instruct the display to display the second operational parameter in the second portion based on the user input to the first portion, receive user input associated with the first operational parameter to the second portion detected by the at least one user input component, and instruct the display to display the first screen in the first portion.

In examples, (a) the controller may be programmed to receive user input associated with the second operational parameter to the second portion with the at least one user input component and instruct the display to display the second screen in the first portion, (b) the first operational parameter and the second operational parameter each may comprise a different one of a treatment mode, a treatment time, and a treatment temperature, (c) the domestic appliance may further comprise a timer programmed to track treatment time, and (d) the domestic appliance may further comprise at least one treatment element configured to treat the contents, a treatment chamber, and a door to enclose the contents in the treatment chamber.

Another aspect of the present technology is directed to a method for controlling a domestic appliance, the domestic appliance having a display with a primary display portion and a secondary display portion adjacent to the primary display portion, a controller, and at least one user input component with a primary input portion and a secondary input portion. The method includes displaying a first parameter group in the primary display portion and displaying a second parameter group in the secondary display portion, detecting user input associated with a parameter of the first parameter group or the second parameter group with the at least one user input component, determining whether the user input was made to the primary input portion or the secondary input portion with the controller, when the user input was made to the primary input portion: determining a value of the parameter associated with the user input with the controller, displaying said value in the secondary display portion, and displaying a third parameter group in the primary display portion; or when the user input was made to the secondary input portion: determining a parameter group of the parameter associated with the user input from among a plurality of parameter groups and displaying said parameter group in the primary display portion.

In examples, (a) the parameter may comprise a treatment mode, a treatment time, or a treatment temperature, (b) the method may comprise displaying a treatment mode screen; receiving a treatment mode input corresponding to a treatment mode from the at least one user input component; displaying a treatment temperature screen; receiving a treatment temperature input corresponding to a treatment temperature from the at least one user input component; displaying a set timer screen; receiving a set timer input from the at least one user input component; displaying a treatment time screen; and receiving a treatment time input corresponding to a treatment time from the at least one user input component, (c) the method may comprise programming the timer to track a treatment time, (d) the method may comprise tracking a treatment time with the timer, and/or (e) the method may comprise treating contents of the domestic appliance with the at least one treatment element for the duration of the treatment time.

Another aspect of the present technology is directed to a domestic appliance to treat contents. The domestic appliance includes a display having a primary display portion and a secondary display portion adjacent to the primary display portion, said display configured to display one of a first parameter group and a second parameter group in one of the primary display portion and the secondary display portion; at least one user input component configured to detect user input to a primary input portion and a secondary input portion, said user input associated with one of the first parameter group and the second parameter group; a controller programmed to determine whether said user input was made to the primary input portion or the secondary input portion; wherein when the user input was made to the primary input portion, the controller may be programmed to determine a parameter value associated with said user input, the display configured to display said parameter value in said secondary display portion and display a third parameter group in the primary display portion; and wherein when the user input was made to the secondary input portion, the controller may be programmed to determine a fourth parameter group of the parameter associated with the user input and the display configured to display the fourth parameter group in the primary portion.

In examples, (a) the domestic appliance may comprise a timer programmed to track a treatment time period; the at least one user input component programmed to receive a treatment time input corresponding to a treatment time; and a controller programmed to set the timer with the treatment time in accordance with the received treatment time input, (b) the domestic appliance may comprise a memory device to store the treatment time input and the expiration function input, (c) the display may comprise a thin film transistor display, (d) the at least one user input component may comprise a capacitive touch input element, and/or (e) an oven; a treatment chamber; at least one treatment element; and a door to enclose the treatment chamber.

Another aspect of the present technology is directed to a method for displaying operational parameters associated with a domestic appliance having a display with a primary portion and a status portion adjacent to the primary display portion and having an input element. The method includes displaying a treatment parameter screen for inputting at least one treatment parameter on a primary portion of the display; then inputting a treatment parameter with the input element; then displaying on a status side of the display a status screen that shows the treatment parameter once it has been inputted; then selecting the inputted treatment parameter from the status side of the display; and then displaying the treatment parameter screen on the primary portion of the display.

In examples, (a) the parameter may comprise a treatment mode, a treatment time, or a treatment temperature, (b) the method may comprise displaying a treatment mode screen; receiving a treatment mode input corresponding to a treatment mode from the at least one user input component; displaying a treatment temperature screen; receiving a treatment temperature input corresponding to a treatment temperature from the at least one user input component; displaying a set timer screen; receiving a set timer input from the at least one user input component; displaying a treatment time screen; and receiving a treatment time input corresponding to a treatment time from the at least one user input component, (c) the method may comprise programming the timer to track treatment time, (d) the method may comprise tracking a treatment time with the timer, and/or (e) the method may comprise treating contents of the domestic appliance with at least one treatment element for the duration of the treatment time

Other aspects, features, and advantages of this technology will become apparent from the following detailed description when taken in conjunction with the accompanying drawings, which are a part of this disclosure and which illustrate, by way of example, principles of this technology.

### BRIEF DESCRIPTION OF THE DRAWINGS

The accompanying drawings facilitate an understanding of the various examples of the present technology. In such drawings:

FIG. 1 is a perspective view of a domestic appliance having a user interface, according to an example of the present technology.

FIG. 2 is a schematic of the user interface, according to an example of the present technology.

FIG. 3 is a block diagram of a processing system, according to an example of the present technology.

FIG. 4 is a flowchart of a method of controlling a domestic appliance, according to an example of the present technology.

FIG. 5 is a flowchart of a method of controlling a domestic appliance, according to another example of the present technology.

FIG. 6 is a flowchart of a method of controlling a domestic appliance, according to another example of the present technology.

FIG. 7 is a flowchart of a method of controlling a domestic appliance, according to another example of the present technology.

FIG. 8 is a flowchart of a method of controlling a domestic appliance, according to another example of the present technology.

FIG. 9 is a screen that may be displayed by a domestic appliance, according to another example of the present technology.

FIG. 10 is a screen that may be displayed by a domestic appliance, according to another example of the present technology.

FIG. 11 is a screen that may be displayed by a domestic appliance, according to another example of the present technology.

FIG. 12 is a screen that may be displayed by a domestic appliance, according to another example of the present technology.

### DETAILED DESCRIPTION OF ILLUSTRATED EMBODIMENTS

The following description is provided in relation to several examples which may share common characteristics and features. It is to be understood that one or more features of any one example may be combinable with one or more features of the other examples. In addition, any single feature or combination of features in any of the examples may constitute additional examples.

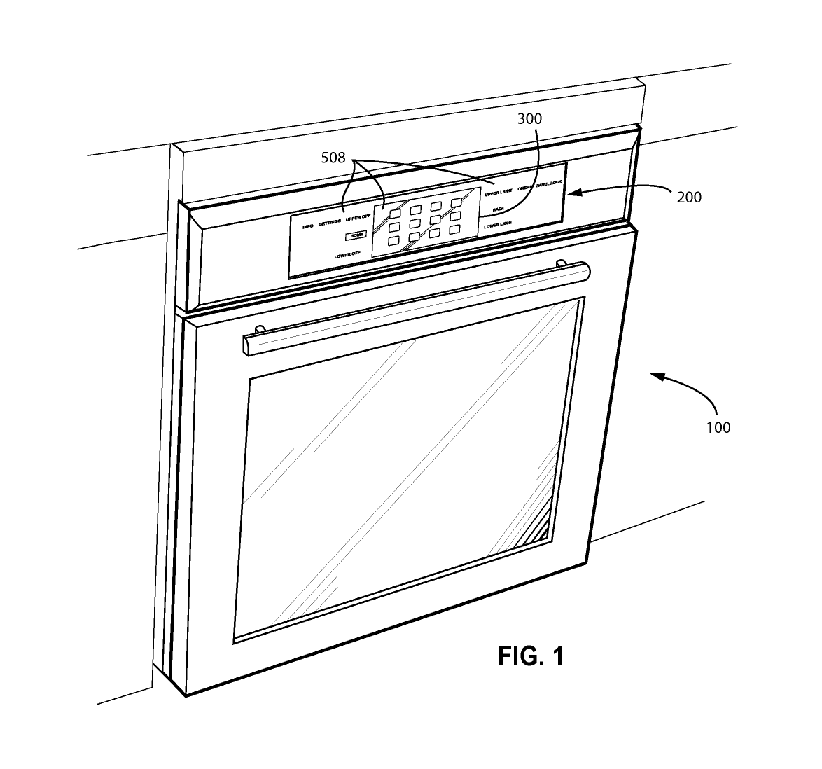

FIG. 1 shows a perspective view of a domestic appliance 100 installed as it commonly would be in a home. The particular domestic appliance 100 shown is an oven installed in a wall of a kitchen. The domestic appliance 100 of FIG. 1 shows a user interface 200 having a display 300. In this example, the display 300 may be a thin film transistor display that may include at least one user input component 508 that may be a capacitive touch input element.

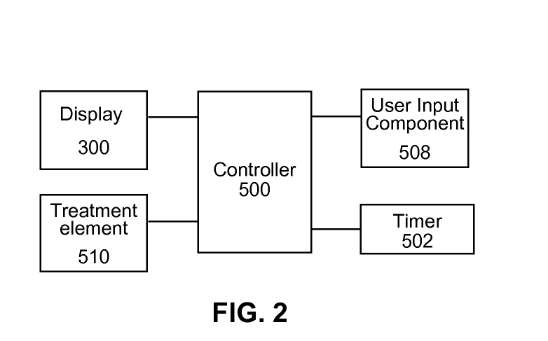

FIG. 2 shows a schematic of the components of the user interface of a domestic appliance in accordance with the present technology. The components may include a controller 500 for coordinating the operation of the user interface. A display 300 may be operationally controlled by the controller 500. A timer 502 may be included to time how long a particular screen is displayed on the display 300 or to time a period of inactivity. The period of inactivity being a time during which no user input is detected by the system. The user input component 508 may be any type of component that receives an input from a user and communicates or programs the same to the controller 500. Specifically, it is envisioned that commonly known touchscreen input devices, such as a capacitive touch input element, will comprise the user input component.

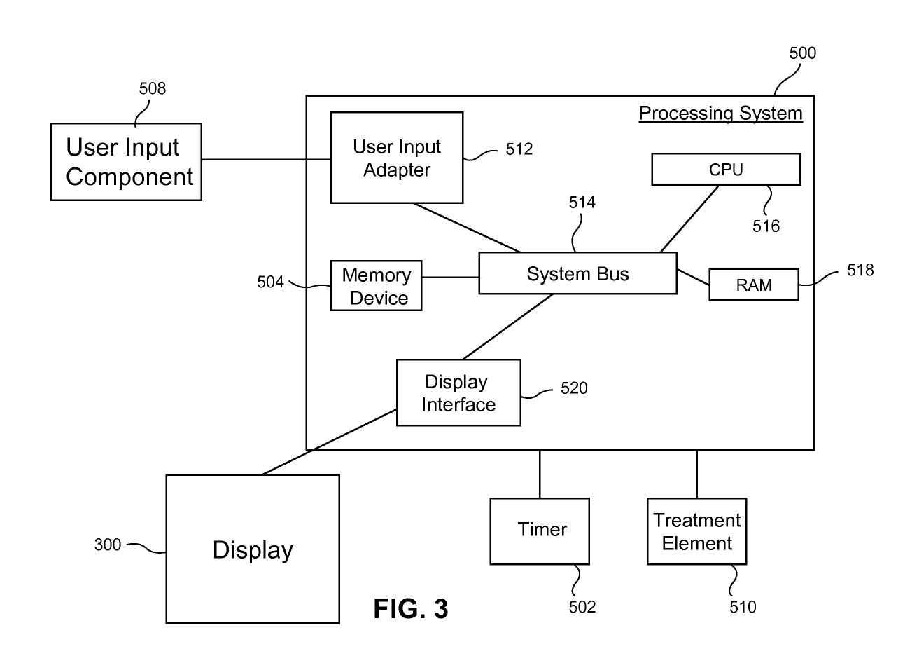

FIG. 3 is a block diagram of an exemplary computing system according to certain examples. A processing system or controller 500 may include a central processing unit or CPU 516, a system bus 514 that communicates with RAM 518 and storage or a memory device 504. The storage 504 can be magnetic, flash based, solid state, or other storage technology. The system bus 514 may also communicate with a user input adapter 512 that allows users to input commands to the processing system via a user input component 508 (e.g., a touch input element or the like) and/or buttons. The results of the processing may be displayed to a user on a display 300 via a display interface 520 (e.g., a video card or the like). The memory device 504 may be included to store the functional parameters (e.g., treatment time, treatment mode, treatment temperature, etc.) input to the controller 500 through the user input component 508. At least one treatment element 510 may also be included for the treatment of the contents of the appliance.

The treatment element(s) 510 may be included to facilitate the treatment of contents by the domestic appliance 100. For example, the domestic appliance 100 may also include a chamber that holds the contents and a door to enclose the contents in the domestic appliance 100 and such domestic appliance may be an oven, a dishwasher, a washing machine, a drier, a microwave oven, a coffee maker, a refrigerator, and/or a freezer, etc. Thus, the contents may be food, consumable liquids, crockery, dishes, stoneware, flatware, bakeware, and/or clothing, etc. It is also contemplated that the domestic appliance may not necessarily include a chamber for treating the contents or items and in such a case the domestic appliance may be a vacuum cleaner, a blender, and an iron, etc. Treatment by the domestic appliance is contemplated to comprise cooking, baking, heating, steaming, sanitizing, dis-infecting, cooling, freezing, cleaning, washing, vacuuming, and/or blending, etc. The treatment element 510, in the example where the appliance 100 is an oven and the contents are food, is at least one heating element that may include an electric resistance heating element or a gas burner. A fan may also comprise the treatment element 510 in the case of a convection oven that performs convection heating of the food. Other treatment elements, as commonly known in the art, may also comprise the treatment element.

The processing system 500 may also communicate with the additional components of the domestic appliance, e.g., timer 502 and treatment element 510. It should also be noted that the timer 502 may be comprised within the processing system 500, rather than as a separate component.

Certain examples herein are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both.

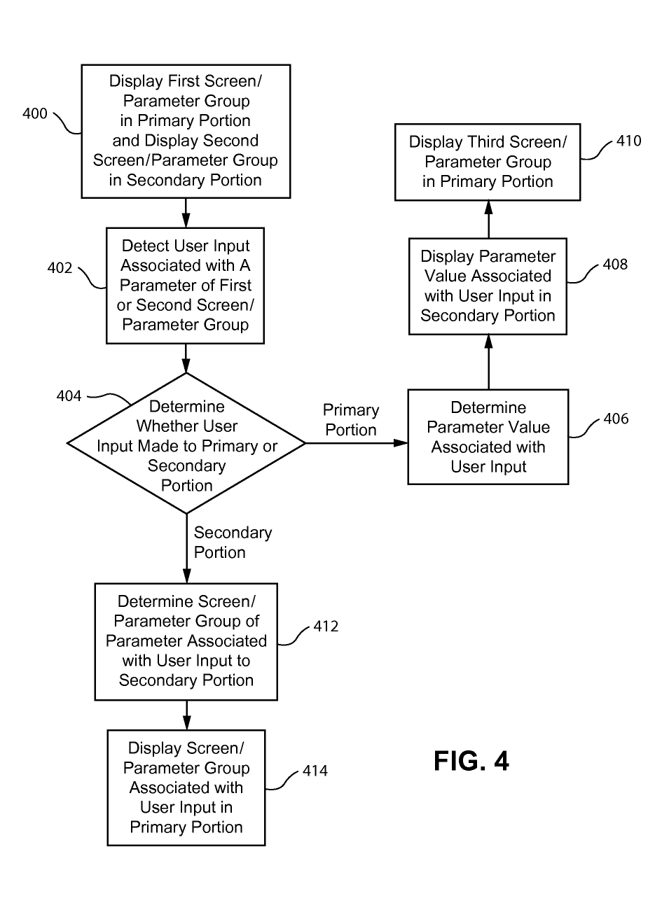

FIG. 4 is a flowchart detailing a method of controlling a domestic appliance according to an example of the present technology. The display 300 of the domestic appliance 100 may include two display portions, a first display portion and a second display portion or a primary display portion and a secondary display portion. The at least one user input component 508 may also be included coextensively with the display 300 and may include a touch input element such as a capacitive touch panel. The at least one user input component may also include two input portions, a first input portion and a second input portion or a primary input portion and a secondary input portion. In the example, where the display 300 and the at least one user input component 508 are coextensive, the first or primary display portion and the second or secondary display portion may correspond to the first or primary input portion and the second or secondary input portion, respectively. Additionally or alternatively, the second or secondary display portion of the display 300 may be a status bar, screen, and/or menu that may persistently display at least one parameter of the domestic appliance, such that the at least one parameter of the status bar that is displayed remains displayed while the user navigates through other screens, menus, and/or parameter groups in the first or primary display portion.

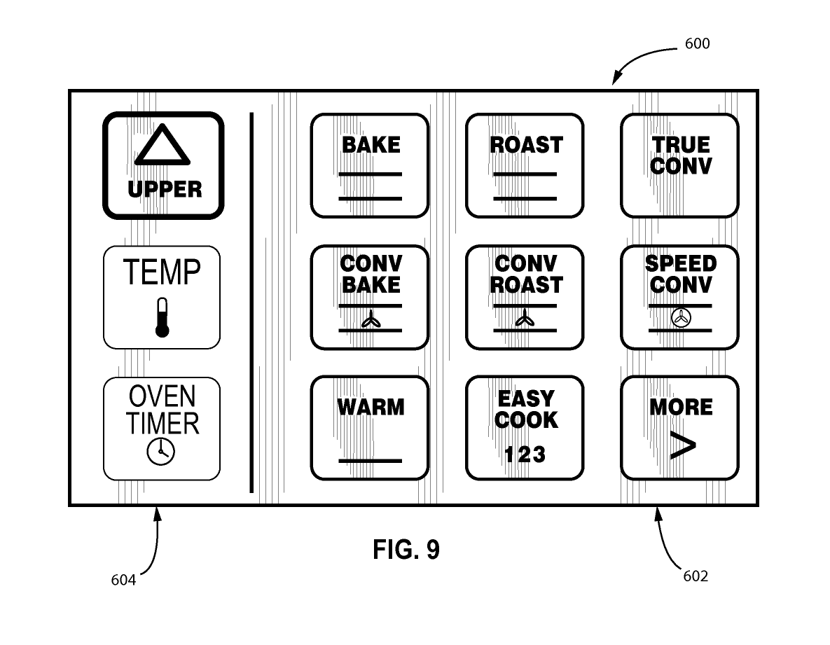

In the example of the method shown in FIG. 4, the display 300 may display a first parameter group in the primary display portion and a second parameter group in the secondary display portion. This function is exemplified by step 400. The user input component 508 may then detect user input associated with a parameter of the first or second parameter group, as exemplified by step 402. The parameter may include a treatment time, a treatment temperature, and/or a treatment mode, etc. The controller 500 may then determine whether the user input was made to the primary input portion or the secondary input portion, as exemplified by step 404. Exemplary views of first and second display portions or screens of the display 300 showing first and second parameter groups may be seen in FIGS. 9-12, further description of which can be found below.

If the user input was made to the primary input portion, thus corresponding to one of the parameters of the first parameter group, the controller 500 may then determine a value of that parameter that is associated with the user input. This function is exemplified by step 406. The display 300 may then display the parameter value in the secondary display portion, as exemplified by step 408. Then, the display 300 may display a third parameter group in the primary display portion, which is shown as step 410.

If the user input was made to the secondary input portion, thus corresponding to one of the parameters of the second parameter group, the controller 500 may then determine an additional or fourth parameter group associated with the parameter of the user input. The additional parameter group may be from among a plurality of parameter groups. The display 300 may then display the additional parameter group in the primary display portion.

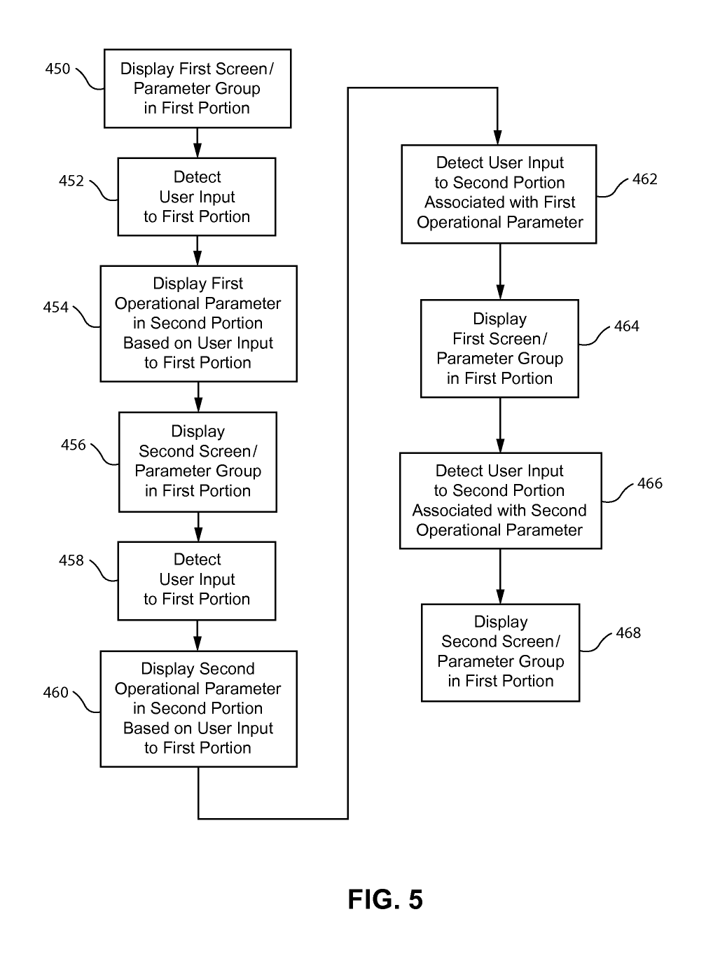

An alternative or additional method of controlling the domestic appliance is exemplified by the flowchart of FIG. 5. Similar to the method shown in FIG. 4, the display 300 of the domestic appliance 100 may include two display portions, a first display portion and a second display portion or a primary display portion and a secondary display portion. The at least one user input component 508 may also be included coextensively with the display 300 and may include a touch input element such as a capacitive touch panel. The at least one user input component may also include two input portions, a first input portion and a second input portion or a primary input portion and a secondary input portion. In the example, where the display 300 and the at least one user input component 508 are coextensive, the first or primary display portion and the second or secondary display portion may correspond to the first or primary input portion and the second or secondary input portion, respectively. Additionally or alternatively, the second or secondary display portion of the display 300 may be a status bar, screen, and/or menu that may persistently display at least one parameter of the domestic appliance, such that the displayed at least one parameter of the status bar remains displayed while the user navigates through other screens, menus, and/or parameter groups in the first or primary display portion.

In the exemplary method of FIG. 5, the display 300 may display a first screen in a first portion, as shown by step 450. The user input component 508 may then detect user input to the first portion associated with a first operational parameter, as exemplified by step 452. The first operational parameter may include a treatment time, a treatment temperature, and/or a treatment mode, etc. Responsive to the user input to the first portion, the display 300 may display the first operational parameter in the second portion. This function is exemplified by step 454. The display 300 may then display a second screen in the first portion, as exemplified by step 456. The user input component 508 may then detect user input to the first portion associated with a second operational parameter, as exemplified by step 458. The second operational parameter may include a treatment time, a treatment temperature, and/or a treatment mode, etc., and the second operational parameter may be different from the first operational parameter. Responsive to the user input to the first portion, the display 300 may display the second operational parameter in the second portion. This function is exemplified by step 460.

The at least one user input component 508 may then detect user input to the second portion, the user input being associated with the first operational parameter. This function is exemplified by step 462. The display 300 may then display the first screen in the first portion, as exemplified by step 464. The at least one user input component 508 may then detect user input to the second portion, the user input being associated with the second operational parameter. This function is exemplified by step 466. The display 300 may then display the second screen in the first portion, as exemplified by step 464. Exemplary views of first and second display portions or screens of the display 300 showing first and second operational parameters may be seen in FIGS. 9-12, further description of which can be found below.

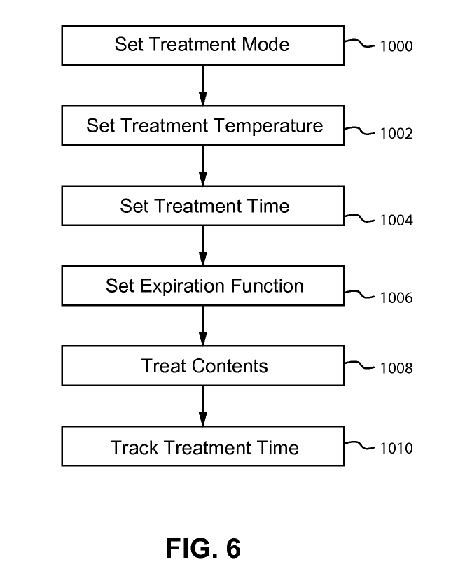

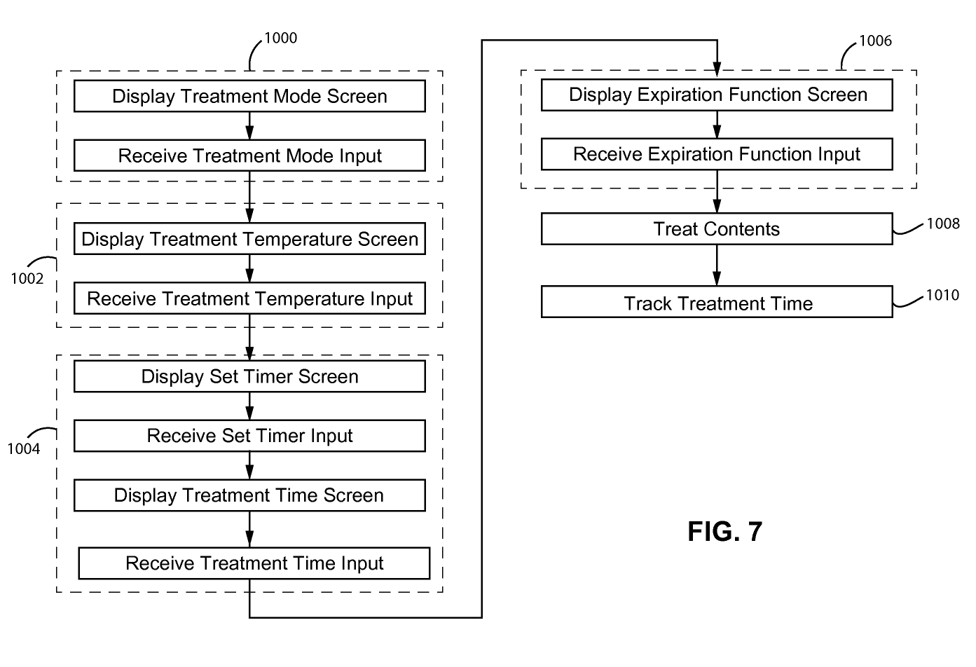

FIGS. 6 and 7 show two corresponding flowcharts that describe further functionality of the domestic appliance that may be additional or alternative to the functions described with respect to FIGS. 4 and 5. The exemplary method described subsequently may be followed to program various operational or treatment parameters to the domestic appliance, while the method described with respect to FIGS. 4 and 5 may be followed by the user to navigate between the various phases of parameter programming. This is advantageous because the user following the method described below may desire to review or reprogram the various parameters with the methods described by FIGS. 4 and 5.

The user begins the process of programming the domestic appliance 100 to treat contents therein with setting the treatment mode, as exemplified by step 1000. This step 1000 includes the controller 500 directing the display 300 to display a treatment mode screen, wherein the user can select from a variety of treatment modes. An exemplary treatment mode screen 600 is shown in FIG. 9. The user then selects the desired treatment input mode by inputting that mode to the user input component 508.

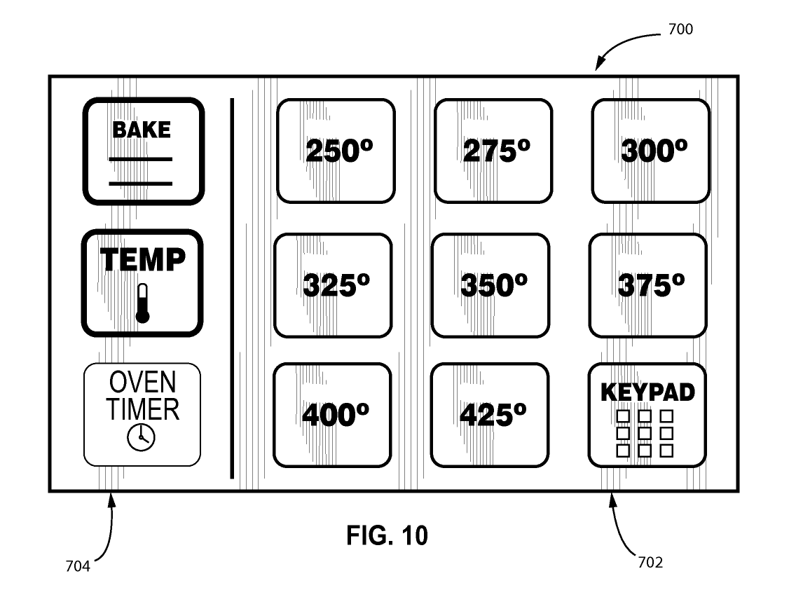

The next step is for the user to set the treatment temperature, which is a prescribed temperature according to a recipe, in the example of the oven that cooks food. Once the treatment mode has been selected, according to the previous step discussed above, the controller 500 will then direct the display 300 to display a treatment temperature screen. This function is exemplified by step 1002. An example of a treatment temperature screen 700 is shown in FIG. 10. The desired treatment temperature is then chosen by the user by inputting this parameter through the user input component 508.

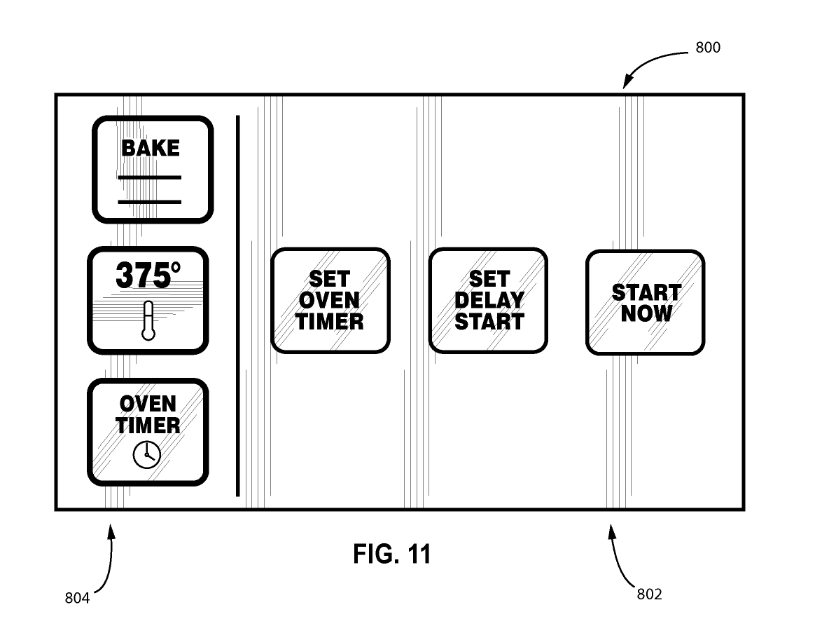

The next step is for the user to input whether the treatment of the contents is to be timed by a timer, as exemplified by step 1004. In this step the controller 500 directs the display 300 to show the user a set timer screen 800, an example of which is shown in FIG. 11. The user may choose to begin treatment right away and not time the treatment by choosing the “START NOW” option or the user may choose to delay the treatment by selecting the “SET DELAY START” option. The user may also choose to set a timer 502 for the treatment and any of these options may be inputted through the user input component 508.

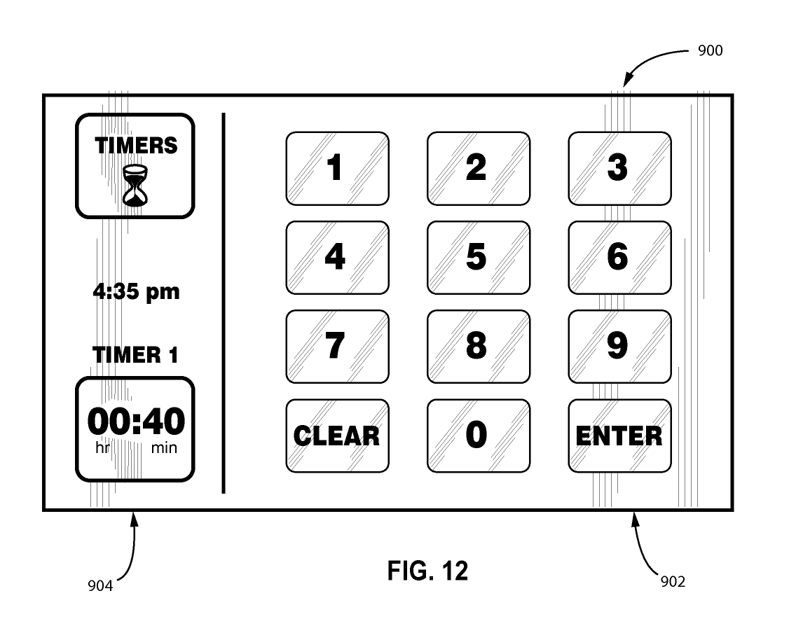

If the user has chosen to have the treatment of the contents timed by a timer 502, the next step will be to set the time for treatment, also exemplified by step 1004. Upon inputting to the controller 500 through the user input component 508 the set timer input, the user will subsequently be displayed a treatment time screen. FIG. 12 shows an exemplary treatment time screen 900 wherein the user inputs, through the user input component 508 to the controller 500, the desired treatment time.

Once each operational parameter is inputted to the controller 500 through the user input component 508, each parameter may be stored in a memory device 504 of the user interface 200.

Also, once each operational parameter is inputted by the user, the domestic appliance 100 is ready to initiate treatment of its contents. At this point the treatment element 510 may be turned on by the controller 500 to begin treatment at the instruction of the user with user input, as exemplified by step 1008.

Once treatment has begun the timer 502 of the user interface 200 tracks the treatment time. This function is exemplified by step 1010. Upon expiration of the treatment time, the timer 502 communicates to the controller 500 that the treatment time has expired.

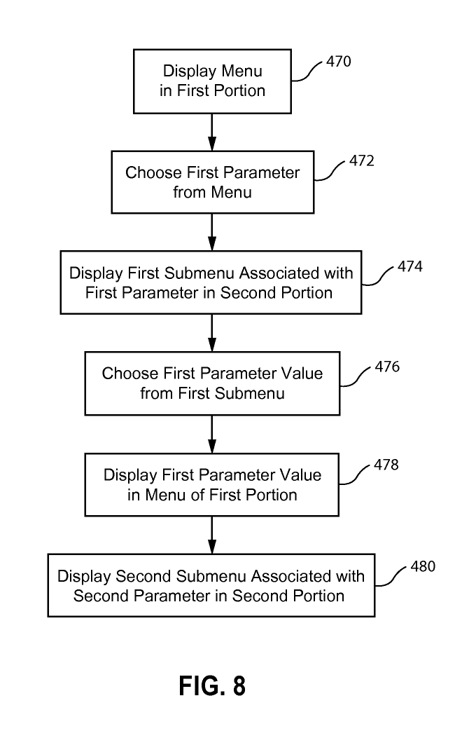

FIG. 8 shows a flowchart of another exemplary method for controlling a domestic appliance 100. The domestic appliance 100 that is controlled may have similar structure to the aforementioned domestic appliances, i.e., a display 300, a controller 500, and at least one user input component 508. First, a menu is displayed in a first portion of the display 300, as exemplified by step 470. The menu may comprise at least one parameter or parameter value, or a plurality thereof. In this particular example, the parameters may include a treatment mode, a treatment temperature, and/or a treatment time. Also, in this particular example, the parameter values may include specific values that may be chosen within each of the aforementioned groups of parameters. Treatment mode values may include, bake, roast, true convection, convection bake, convection roast, speed convection, or warm, etc. Treatment temperature may be any temperature value chosen by the user at which the domestic appliance is capable of treating contents and treatment time may be any length of time desired by the user or prescribed by a recipe.

Step 472 exemplifies the next step of the method wherein the user chooses a first parameter from the menu and the at least one user input component 508 detects the user input. The display 300 may then display a first submenu that is associated with the first parameter in the second portion. This function is exemplified by step 474. Next, the user may choose a first parameter value from the first submenu and the at least one user input component 508 may detect the user input. This function is exemplified by step 476. The display 300 may then display the chosen first parameter value in the menu of the first portion, as exemplified by step 478. The display 300 may then display a second submenu associated with a second parameter in the second portion. Step 480 exemplifies this function.

The functionality of this method is advantageous for the user because it allows the menu or status bar to be persistently displayed by a portion of the display while the user inputs desired treatment parameters to the submenus. Thus, the user can see which treatment parameters have been programmed and which values have been chosen while programming other parameter values or otherwise operating the appliance.

With respect to the method shown in FIG. 8, the screens shown in FIGS. 9-12 depict a number of different possible menus and submenus, as will be described further below. Reference numerals 604, 704, 804, and 904 indicate the menu displayed in this example. Reference numerals 602, 702, 802, and 902 indicate the submenu displayed in this example.

FIG. 9 shows an exemplary screen that may be displayed by the display 300, according to an example of the present technology. The screen shown in this view is a treatment mode screen 600. The display portion 602 shows, for example, a first parameter group with a plurality of treatment modes by which the domestic appliance may operate. The display portion 604 may show a second parameter group or a status bar and may show a parameter chosen from the display portion 602. For example, if “BAKE” was chosen from the display portion 602, the display portion 604 may then display “BAKE” as a chosen parameter, as shown subsequently in FIG. 10.

FIG. 10 shows another exemplary screen that may be displayed by the display 300, according to an example of the present technology. The screen shown in this view is a treatment temperature screen 700. The display portion 702 shows, for example, a first parameter group with a plurality of treatment temperatures by which the domestic appliance may operate. The display portion 704 may show a second parameter group or a status bar and may show a parameter chosen from the display portion 702. For example, if “375°” was chosen from the display portion 702, the display portion 704 may then display “375°” as a chosen parameter, as shown subsequently in FIG. 11.

FIGS. 11 and 12 show additional exemplary screens that may be displayed by the display 300, according to an example of the present technology. The screens shown in this view are a set timer screen 800 and a treatment time screen 900. The display portions, 802 and 902, show options for the user to program a treatment time to the timer. Screen 802 allows the user to choose to time the treatment by choosing “SET OVEN TIMER” and screen 902 allows the user to program the time. Display portion 902 may then show the programmed treatment time as part of a second parameter group or a status bar. For example, if the user chooses to program a timer by choosing “SET OVEN TIMER” in the screen 802 of FIG. 11 and then programs a treatment time of 40 minutes in the screen 902 of FIG. 12, this parameter value will be shown in the display portion or status bar 904, as in FIG. 12.

While the present technology has been described in connection with what are presently considered to be the most practical and preferred examples, it is to be understood that the technology is not to be limited to the disclosed examples, but on the contrary, is intended to cover various modifications and equivalent arrangements included within the spirit and scope of the technology.

What is claimed is:

1. A method for controlling a domestic appliance, said domestic appliance having a display with a first portion and a second portion, a controller, and at least one user input component, the method comprising:
displaying a menu in the first portion;
detecting user input associated with a first parameter of said menu with the at least one user input component;
displaying a first submenu in the second portion;
detecting user input associated with a first parameter value of said first submenu with the at least one user input component;
displaying the first parameter value in the menu in the first portion; and
displaying a second submenu associated with a second parameter in the second portion.

2. The method of claim 1, wherein the first parameter and the second parameter each comprise a different one of a treatment mode, a treatment temperature, and a treatment time.

3. The method of claim 2, wherein the first parameter value comprises a value of one of a plurality of treatment modes, one of a plurality of treatment temperatures, or one of a plurality of treatment times.

4. The method of claim 1, wherein the menu is persistently displayed in said first portion independent of the submenu displayed in said second portion.

5. The method of claim 1, wherein said domestic appliance further comprises at least one treatment element; and
wherein the method further comprises treating contents within a treatment chamber enclosed by a door with the at least one treatment element according to at least the first parameter value.

6. The method of claim 1, further comprising:
displaying a plurality of parameter values in the menu in the first portion.

7. The method of claim 1, wherein each said submenu comprises a plurality of parameter values associated with each respective submenu parameter.

8. A domestic appliance to treat contents, the domestic appliance comprising:
a display with a first portion and a second portion;
at least one user input component configured to detect user input; and
a controller programmed to:
instruct the display to display a menu in the first portion;
receive user input associated with a first parameter of said menu from the at least one user input component;
instruct the display to display a first submenu in the second portion;
receive user input associated with a first parameter value of said first submenu from the at least one user input component;
instruct the display to display the first parameter value in the menu in the first portion; and
instruct the display to display a second submenu associated with a second parameter in the second portion.

9. The domestic appliance of claim 8, wherein the first parameter and the second parameter each comprise a different one of a treatment mode, a treatment temperature, and a treatment time.

10. The domestic appliance of claim 9, wherein the first parameter value comprises one of a plurality of treatment modes, one of a plurality of treatment temperatures, or one of a plurality of treatment times.

11. The domestic appliance of claim 8, wherein the controller is programmed to instruct the display to persistently display the menu in said first portion independent of the submenus displayed in said second portion.

12. The domestic appliance of claim 8, further comprising:
at least one treatment element;
a treatment chamber; and
a door to enclose the treatment chamber, wherein the controller is programmed to instruct the at least one treatment element to treat the contents within the treatment chamber enclosed by the door with the at least one treatment element according to at least the first parameter value.

13. The domestic appliance of claim 8, wherein the controller is programmed to instruct the display to display a plurality of parameter values in the menu in the first portion.

14. The domestic appliance of claim 8, wherein each said submenu comprises a plurality of parameter values associated with each respective submenu parameter.

15. A method for displaying at least one operational parameter associated with a user interface of a domestic appliance, said user interface having a display with a first portion and a second portion and having at least one user input component, the method comprising:
displaying a first screen associated with a first operational parameter in the first portion;
detecting user input to the first portion with the at least one user input component;
displaying the first operational parameter in the second portion based on the user input to the first portion;
displaying a second screen associated with a second operational parameter in the first portion;
detecting user input to the first portion with the at least one user input component;
displaying the second operational parameter in the second portion based on the user input to the first portion;
detecting user input associated with the first operational parameter to the second portion with the at least one user input component; and
displaying the first screen in the first portion.

16. The method of claim 15, further comprising:
detecting user input associated with the second operational parameter to the second portion with the at least one user input component; and
displaying the second screen in the first portion.

17. The method of claim 15, wherein the at least one operational parameter comprises a treatment mode, a treatment time, or a treatment temperature.

18. The method of claim 15, further comprising:
displaying a treatment mode screen;
receiving a treatment mode input corresponding to a treatment mode from the at least one user input component;
displaying a treatment temperature screen;
receiving a treatment temperature input corresponding to a treatment temperature from the at least one user input component;
displaying a set timer screen;
receiving a set timer input from the at least one user input component;
displaying a treatment time screen; and
receiving a treatment time input corresponding to a treatment time from the at least one user input component.

19. The method of claim 18, wherein the domestic appliance further comprises a timer, and
wherein the method further comprises programming the timer to track a treatment time.

20. The method of claim 19, further comprising:
tracking a treatment time with the timer.

21. The method of claim 20, wherein the domestic appliance further comprises at least one treatment element, and
wherein the method further comprises:
treating contents of the domestic appliance with the at least one treatment element for the duration of the treatment time.

22. A domestic appliance to treat contents, the domestic appliance comprising:
a display with a first portion and a second portion;
at least one user input component configured to detect user input; and
a controller programmed to:
instruct the display to display a first screen associated with a first operational parameter in the first portion;
receive user input to the first portion detected by the at least one user input component;
instruct the display to display the first operational parameter in the second portion based on the user input to the first portion;
instruct the display to display a second screen associated with a second operational parameter in the first portion;
receive user input to the first portion detected by the at least one user input component;
instruct the display to display the second operational parameter in the second portion based on the user input to the first portion;
receive user input associated with the first operational parameter to the second portion detected by the at least one user input component; and
instruct the display to display the first screen in the first portion.

23. The domestic appliance of claim 22, wherein the controller is programmed to receive user input associated with the second operational parameter to the second portion with the at least one user input component and instruct the display to display the second screen in the first portion.

24. The domestic appliance of claim 22, wherein the first operational parameter and the second operational parameter each comprise a different one of a treatment mode, a treatment time, and a treatment temperature.

25. The domestic appliance of claim 22, wherein the controller is programmed to:
instruct the display to display a treatment mode screen;
receive a treatment mode input corresponding to a treatment mode detected by the at least one user input component;
instruct the display to display a treatment temperature screen;
receive a treatment temperature input corresponding to a treatment temperature detected by the at least one user input component;
instruct the display to display a set timer screen; receive a set timer input detected by the at least one user input component;
instruct the display to display a treatment time screen; and
receive a treatment time input corresponding to a treatment time from the at least one user input component.

26. The domestic appliance of claim 22, further comprising:
a timer programmed to track treatment time.

27. The domestic appliance of claim 22, further comprising:
at least one treatment element configured to treat the contents;
a treatment chamber; and
a door to enclose the contents in the treatment chamber.

28. A method for controlling a domestic appliance, said domestic appliance having a display with a primary display portion and a secondary display portion, a controller, and at least one user input component with a primary input portion and a secondary input portion, the method comprising:
displaying a first parameter group in the primary display portion and displaying a second parameter group in the secondary display portion;
detecting user input associated with a parameter of the first parameter group or the second parameter group with the at least one user input component;
determining whether the user input was made to the primary input portion or the secondary input portion with the controller;
when the user input was made to the primary input portion:
determining a value of the parameter associated with the user input with the controller;
displaying said value in the secondary display portion; and
displaying a third parameter group in the primary display portion; or
when the user input was made to the secondary input portion:
determining a parameter group of the parameter associated with the user input from among a plurality of parameter groups; and
displaying said parameter group in the primary display portion.

29. The method of claim 28, wherein the parameter comprises a treatment mode, a treatment time, or a treatment temperature.

30. The method of claim 28, further comprising:
displaying a treatment mode screen;
receiving a treatment mode input corresponding to a treatment mode from the at least one user input component;
displaying a treatment temperature screen;
receiving a treatment temperature input corresponding to a treatment temperature from the at least one user input component;
displaying a set timer screen;
receiving a set timer input from the at least one user input component;
displaying a treatment time screen; and
receiving a treatment time input corresponding to a treatment time from the at least one user input component.

31. The method of claim 30, wherein the domestic appliance further comprises a timer, and
wherein the method further comprises programming the timer to track a treatment time.

32. The method of claim 31, further comprising:
tracking a treatment time with the timer.

33. The method of claim 32, wherein the domestic appliance further comprises at least one treatment element, and
wherein the method further comprises:
treating contents of the domestic appliance with the at least one treatment element for the duration of the treatment time.

34. A domestic appliance to treat contents, comprising:
a display having a primary display portion and a secondary display portion, said display configured to display one of a first parameter group and a second parameter group in one of the primary display portion and the secondary display portion;
at least one user input component configured to detect user input to a primary input portion and a secondary input portion, said user input associated with one of the first parameter group and the second parameter group;
a controller programmed to determine whether said user input was made to the primary input portion or the secondary input portion;
wherein when the user input was made to the primary input portion, the controller programmed to determine a parameter value associated with said user input, the display configured to display said parameter value in said secondary display portion and display a third parameter group in the primary display portion; and
wherein when the user input was made to the secondary input portion, the controller programmed to determine a fourth parameter group of the parameter associated with the user input and the display configured to display the fourth parameter group in the primary portion.

35. The domestic appliance of claim 34, further comprising:
a timer programmed to track a treatment time period;
the at least one user input component programmed to receive a treatment time input corresponding to a treatment time; and
a controller programmed to set the timer with the treatment time in accordance with the treatment time input received from the at least one user input component.

36. The domestic appliance of claim 35, further comprising;
a memory device to store the treatment time input.

37. The domestic appliance of claim 34, wherein the display comprises a thin film transistor display.

38. The domestic appliance of claim 34, wherein the at least one user input component comprises a capacitive touch input element.

39. The domestic appliance of claim 34, further comprising:
an oven;
a treatment chamber;
at least one treatment element; and
a door to enclose the treatment chamber.

40. A method for displaying operational parameters associated with a domestic appliance having a display with a primary portion and a status portion and having an input element, the method comprising:
displaying a treatment parameter screen for inputting at least one treatment parameter on a primary portion of the display;
then inputting a treatment parameter with the input element;
then displaying on a status side of the display a status screen that shows the treatment parameter once it has been inputted;
then selecting the treatment parameter inputted from the status side of the display; and
then displaying the treatment parameter screen on the primary portion of the display.

41. The method of claim 40, wherein the treatment parameter comprises a treatment mode, a treatment time, or a treatment temperature.

42. The method of claim 41, further comprising:
displaying a treatment mode screen;
receiving a treatment mode input corresponding to a treatment mode from the input element;
displaying a treatment temperature screen;
receiving a treatment temperature input corresponding to a treatment temperature from the input element;
displaying a set timer screen;
receiving a set timer input from the input element;
displaying a treatment time screen; and
receiving a treatment time input corresponding to a treatment time from the input element.

43. The method of claim 42, wherein the domestic appliance further comprises a timer, and
wherein the method further comprises programming the timer to track a treatment time.

44. The method of claim 43, further comprising:
tracking a treatment time with the timer.

45. The method of claim 44, wherein the domestic appliance further comprises at least one treatment element, and
wherein the method further comprises:
treating contents of the domestic appliance with the at least one treatment element for the duration of the treatment time.
